(19) United States
(12) Patent Application Publication
(10) Pub. No.: US 2007/0278368 A1
(43) Pub. Date: Dec. 6, 2007

(54) MOUNTING MECHANISM

(76) Inventors: David Dunphy, Ingersol (CA); Christopher Leckie, London (CA)

Correspondence Address: VINCENT PATENT AGENCY, 11-300 EARL GREY DRIVE, SUITE 202, KANATA, ON, K2T 1C1, CA

(21) Appl. No.: 11/751,102

(22) Filed: May 21, 2007

Related U.S. Application Data
(60) Provisional application No. 60/747,857, filed on May 22, 2006.

(51) Int. Cl. F16M 11/00

(52) U.S. Cl. 248/201

(57) ABSTRACT

A mounting mechanism for a computer interface device for use in a vehicle. The mounting mechanism provides for the interface device to be mounted onto a control panel of the vehicle so that it is accessible and visible to an occupant of the vehicle in an in-use position. The mounting mechanism provides for the interface device to be rotated between the in-use position and a folded position that mitigates interference with the accessibility and visibility of the control panel. The mounting mechanism comprises device brackets for attachment to the computer interface device, mounting brackets for attachment to the control panel, resistance elements for pivotally connecting the device brackets to the mounting brackets and for resisting the rotation of the device bracket relative to the mounting brackets, and up-stops and down-stops for limiting the rotation of the computer interface device to define the in-use and folded positions respectively.

### CROSS-REFERENCE TO RELATED APPLICATIONS

This application claims priority from U.S. provisional application 60/747,857 filed May 22, 2006 the entirety of which is herein incorporated by reference.

### FIELD OF INVENTION

The present invention relates to the fields of mounting mechanisms and mobile computing. In particular, to a mounting mechanism for a computer interface device in a vehicle.

### BACKGROUND

As the use of personal computing devices becomes more pervasive the need or desire to use a computing device while a passenger in or operator of a vehicle is increasing. While mobile personal computers (PC) are available that are adapted to the operating conditions in vehicles such as automobiles, trucks, boats and airplanes a challenge that remains is in the area of the user interface. Display monitors, keyboard and mice (i.e. pointing devices) that are intended for desktop use do not lend themselves to ease of use in an in-vehicle installation. These devices are typically too large and cumbersome to use in a vehicle. Smaller display devices, such as flat panel displays using liquid crystal devices (LCD) or other similar technology that can incorporate a touch panel overlaying the display are more suitable to in-vehicle use.

Mounting of a flat panel computer interface device in a vehicle also presents challenges. A preferred mounting location for the interface device is one that is easily accessible and in a natural line-of-sight for the vehicle operator and/or the passenger. Typically a location that meets these criteria would be situated on the control panel (e.g. dash board or instrument panel) of the vehicle. The control panel incorporates user controls and instruments that need to be accessible and visible to the vehicle operator and/or passenger as well. Mounting the interface device in a preferred location while still permitting access to the control panel is not always possible using a fixed mounting mechanism.

What is needed is a mounting mechanism for an in-vehicle computer interface device that allows the device to be accessible and visible to the vehicle operator and/or passenger while mitigating any interference with the accessibility and visibility of the vehicle control panel.

### SUMMARY OF INVENTION

A mounting mechanism for a computer interface device for use in a vehicle. The mounting mechanism provides for the interface device to be mounted onto a control panel of the vehicle so that it is accessible and visible to an occupant of the vehicle in an in-use position. The mounting mechanism provides for the interface device to be rotated between the in-use position and a folded position that mitigates interference with the accessibility and visibility of the control panel.

The mounting mechanism comprises device brackets for attachment to the computer interface device, mounting brackets for attachment to the control panel, resistance elements for pivotally connecting the device brackets to the mounting brackets and for resisting the rotation of the device bracket relative to the mounting brackets, and up-stops and down-stops for limiting the rotation of the computer interface device to define the in-use and folded positions respectively.

In one aspect there is provided a mounting mechanism for mounting a computer interface device to a control panel of a vehicle, comprising: a pair of device brackets for fixed attachment to the computer interface device; a pair of mounting brackets adapted to attachment to the control panel; a pair of resistance elements, each for pivotally connecting one device bracket to one mounting bracket and for providing resistance to the pivotal rotation of each device bracket relative to the connected mounting bracket; a pair of up-stops adapted to limiting the pivotal rotation, in a first direction, of the device brackets relative to the mounting brackets; and a pair of down-stops adapted to limiting the pivotal rotation, in a second direction, of the device brackets relative to the mounting brackets; wherein the computer interface device is operable between an in-use position, defined by the up-stops, providing access to the computer interface device by an occupant of the vehicle and a folded position, defined by the down-stops, providing access to an area of the control panel that is obscured by the computer interface device when in the in-use position.

Other aspects and features of the present invention will become apparent to those ordinarily skilled in the art or science to which it pertains upon review of the following description of specific embodiments of the invention in conjunction with the accompanying figures.

### BRIEF DESCRIPTION OF DRAWINGS

The present invention will be described in conjunction with drawings in which:

FIG. 1 is an isometric view of an exemplary embodiment of a mounting mechanism for mounting a computer interface device in a vehicle.

FIG. 2 is an isometric view of an exemplary embodiment of the mounting mechanism for mounting the computer interface device shown in an in-use position.

FIG. 3 is an isometric view of an exemplary embodiment of the mounting mechanism for mounting the computer interface device shown in a folded position

FIG. 4 is a partial isometric view of an exemplary embodiment of the mounting mechanism for mounting the computer interface device shown mounted to the backside of a vehicle control panel.

FIGS. 5A-C are side views of an exemplary embodiment of the mounting mechanism for mounting the computer interface device showing the computer interface device in several positions.

FIG. 6 is a back view of an exemplary embodiment of the mounting mechanism for mounting the computer interface device.

### DETAILED DESCRIPTION

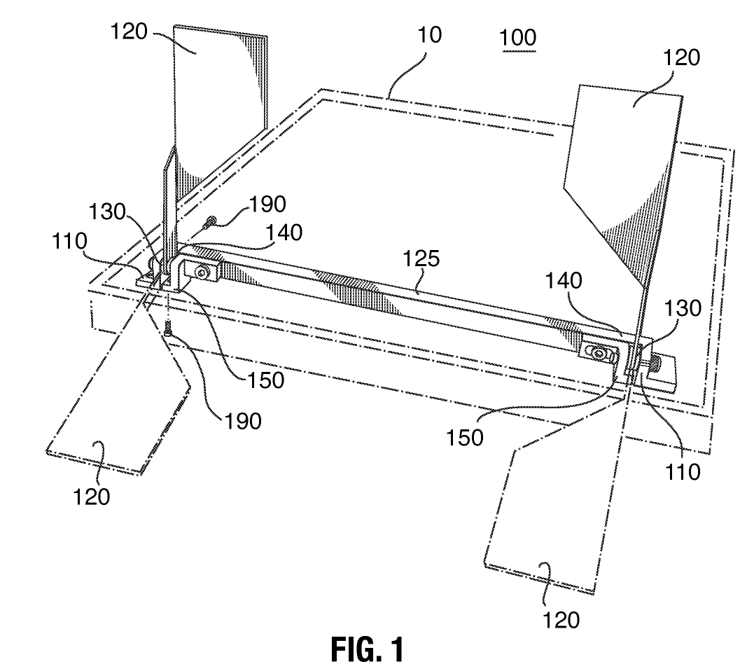

FIG. 1 is a isometric view of an exemplary embodiment of a mounting mechanism 100 for mounting a computer interface device 10 (shown in chain-line) in a vehicle such as an automobile, truck, boat or airplane. The mounting mechanism 100 comprises a pair of device brackets 110, a pair of mounting brackets 120, a pair of resistance elements 130, a pair of up-stops 140 and a pair of down-stops 150. Each of the mounting brackets 120 is shown in a first position in solid line and in a second position in chain-line.

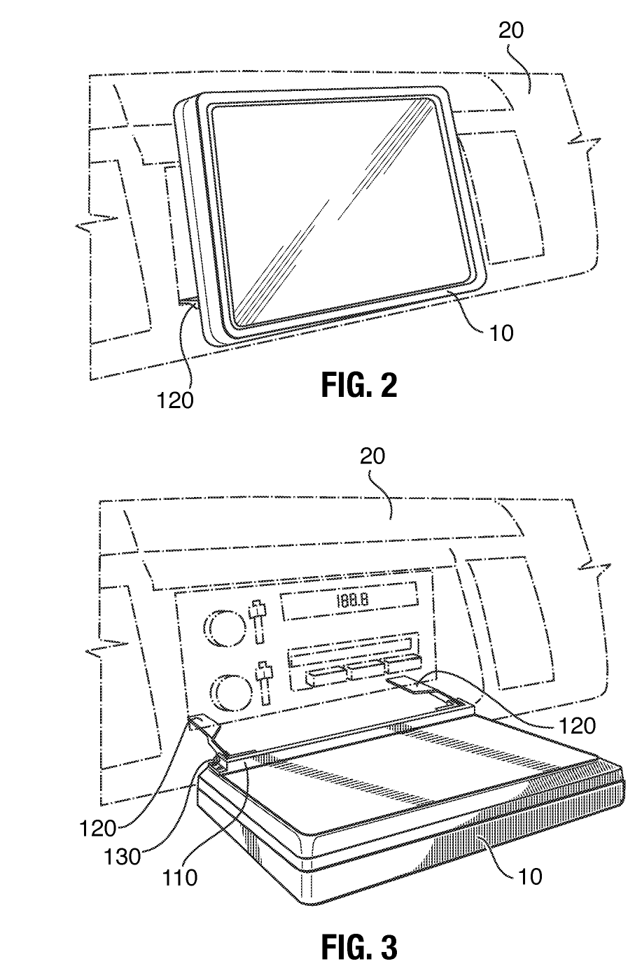

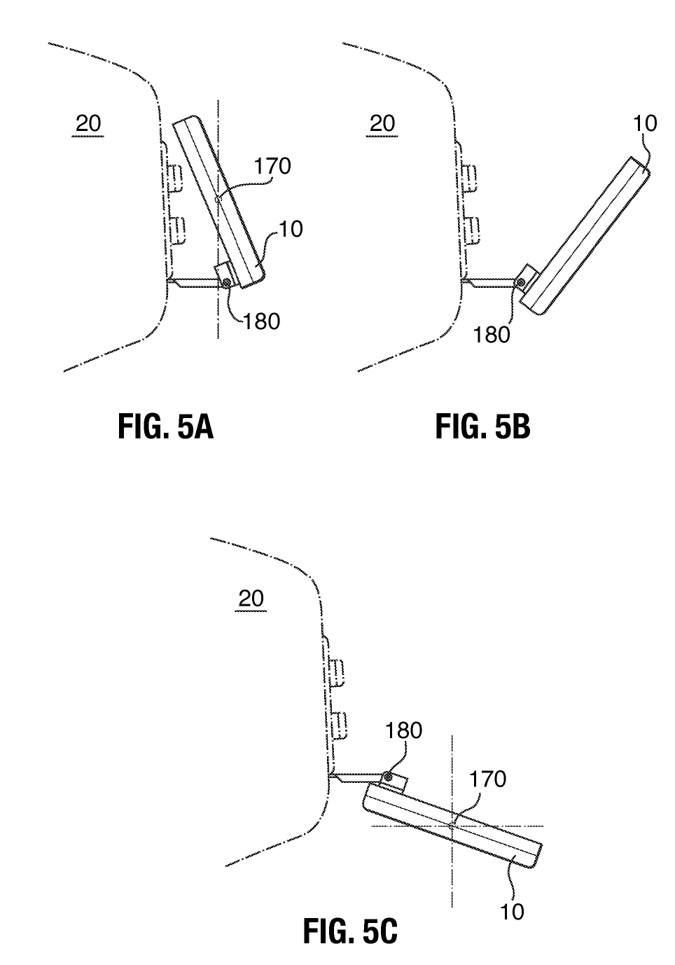

FIGS. 2 and 3 are isometric views of an exemplary embodiment of the mounting mechanism 100 for mounting the computer interface device 10 with the computer interface device 10 shown in an in-use position and in a folded position respectively. FIGS. 5A-C are side views of an exemplary embodiment of the mounting mechanism 100 for mounting the computer interface device 10 showing the computer interface device 10 in the in-use, an intermediate and the folded positions respectfully. The mounting mechanism 100 provides for the mounting of the interface device 10 on to a vehicle control panel 20. The interface device 10 is preferably mounted in a location on the control panel 20 that is easily accessible and in a natural line-of-sight for a vehicle operator and/or a passenger (herein after an occupant). The mounting mechanism 100 provides for the interface device 10 to be operated between an in-use position (FIG. 5A) that is accessible and visible to the occupant and a folded position (FIG. 5C) that mitigates any interference with the accessibility and visibility of the control panel 20.

The interface device 10 can be operatively connected to a mobile PC or other similar computing device for use in the vehicle. The interface device 10 can comprise a display (i.e. monitor) for the mobile PC using a LCD or other similar flat panel technology. The interface device 10 can also comprise a user input device such as a touch panel, push-bottom controls, a joystick, other similar input devices and combinations thereof. The mobile PC can provide functions such as wireless Internet access, Internet browsing, email, messaging, navigation assistance, music playback (e.g. MP3), video playback (e.g. DVD), theft or break-in alarm, personal security, and combinations thereof.

The pair of device brackets 110 is adapted to attachment to the computer interface device 10. Attachment of the device brackets 110 to the computer interface device 10 is preferably fixed attachment which can be accomplish using, for example, mechanical fasteners. Each device bracket 110 can attach to an outer surface of the computer interface device 10 or alternatively to an internal structure contained in the computer interface device 10. The pair of device brackets 110 can optionally be connected by one or more structural members 125.

The device brackets 110, when attached to the interface device 10, are preferably substantially horizontally aligned relative to the orientation of the interface device 10 when installed in the vehicle. The pair of device brackets 110 and the pair of mounting brackets 120 are each spaced apart to permit connection of one device bracket 110 to one mounting bracket 120.

The pair of mounting brackets 120 is adapted to removable mounting to the control panel 20 of the vehicle. In an exemplary embodiment each mounting bracket 120 can be mechanically fastened or bonded to a structural element of the control panel 20 (i.e. a substructure) such as a supporting structures for an entertainment unit (e.g. car radio), a control cluster (e.g. heating and ventilation control unit) or other similar substructure of the control panel 20. The mounting brackets 120 can be adapted to positioning through an aperture in a faceplate or cover of the control panel 20. When installed on the control panel 20, each of the mounting brackets 120 can protrude from the control panel 20 and preferably the pair of mounting brackets 120 is substantially horizontally aligned. The pair of mounting brackets 120 can be adapted to removable attachment to the control panel 20 by for example using mechanical fasteners that preferably attach to pre-existing attachment points in the control panel 20.

The mounting mechanism 100 preferably permits the interface device 10 to be mounted in the vehicle with minimal or no modification to the vehicle control panel 20 and in such a way as to mitigate any cosmetic damage if the mounting mechanism 100 is eventual removed (e.g. when the vehicle is to be sold to a new owner).

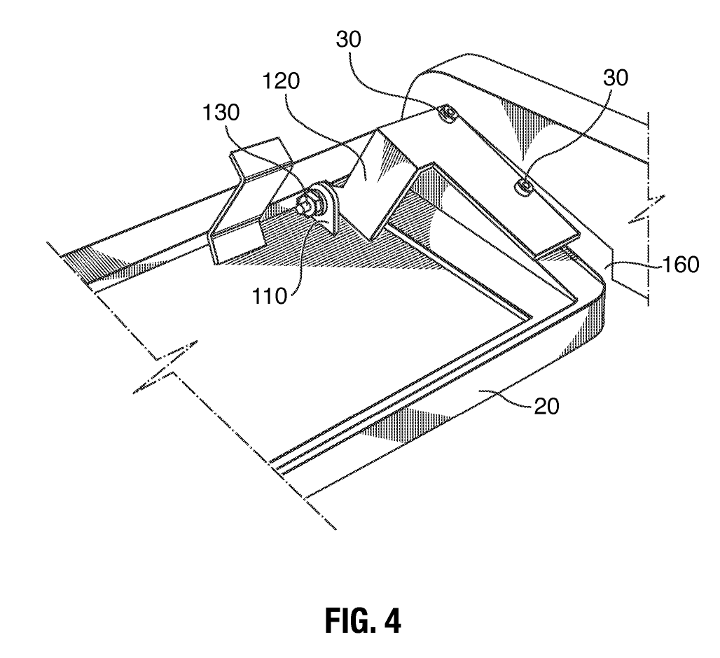

FIG. 4 is a an isometric view of an exemplary embodiment of the mounting mechanism 100, for mounting the computer interface device 10, shown mounted to the backside of the vehicle control panel 20. The mounting bracket 120 (only one is illustrated in FIG. 4) can be secured to the mounting block 160 using mechanical fasteners 30 such as screws, nuts and bolts, rivets or other similar fasteners. The mounting block 160 can be bonded to the control panel 20 using for example, double-side adhesive tape, a curable adhesive, other similar bonding agents and combinations thereof. The bonding of the mounting block 160 to the control panel 20 is preferably releasable so that the mounting blocks 160 can be removed while mitigating cosmetic damage to the control panel 20. The mounting blocks 160 can be bonded to the either the front side or the backside of the control panel 20.

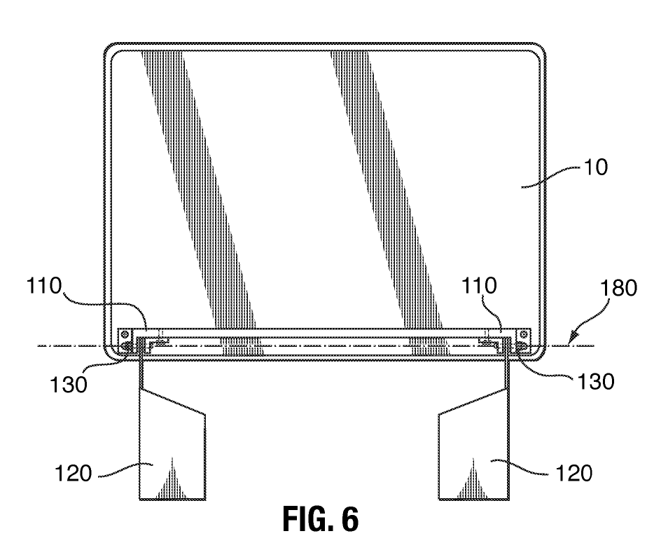

Referring again to FIG. 1 and to FIG. 6 that is a back view of an exemplary embodiment of the mounting mechanism for mounting the computer interface device. The pair of resistance elements 130 is used to pivotally connect the device brackets 110 to the mounting brackets 120. An axis of rotation 180 is defined by the substantially linear alignment of the pair of resistance elements 130. The resistance elements 130 provide resistance to pivoting of the interface device 10 from the in-use position (FIG. 5A) to the folded position (FIG. 5C) and vise versa. The resistance elements 130 provide for the interface device 10 to be stable in the in-use and folded positions and at positions in between (FIG. 5B) including when the vehicle is in motion. The resistance elements 130 can comprise a component made of polytetrafluoroethylene (PTFE) polymer, nylon, rubber or other similar materials that provide resistance (e.g. friction) to the pivotal rotation of the mounting brackets 120 relative to the device brackets 110.

Each of the pair of up-stops 140 is connected to one of the mounting brackets 120 and is arranged to limit the pivotal rotation of the interface device 10 in an upward direction and thereby define the in-use position (FIG. 5A). The up-stops 140 prevent the interface device 10 from contacting the control panel 20 and ensure the interface device 10 is oriented for accessibility and visibility by the occupant. The up-stops 140 preferably orient the interface device 10 in the in-use position such that it is reclined passed the vertical position toward the control panel 20. In the in-use position (FIG. 5A) the center-of-gravity 170 of the computer interface device 10 is between (intermediate) an axis of rotation 180, around which the device brackets 110 rotate relative to the mounting brackets 120, and the control panel 20. This arrangement contributes to the stability of the computer interface device 10 in the in-use position as the force of gravity biases the computer interface device 10 to remain in the in-use position when the vehicle is subjected to vertical movements such as, for example, when traversing road imperfections (e.g. potholes, expansion joints and speed-bumps) in the case of a road vehicle. Each of the pair of up-stops 140 can optionally further comprise an adjustment mechanism 190 for varying the limit to the pivotal rotation of the computer interface device 10 that defines the in-use position. The adjustment mechanism 190 can, for example, comprise one or more set screws threaded through a portion of the up-stops 140 or other similar mechanisms.

Each of the pair of down-stops 150 is connected to one of mounting brackets 120 and is arranged to limit the pivotal rotation of the interface device in a downward direction and thereby define the folded position (FIG. 5C). The down-stops 150 prevent the interface device 10 from contacting the control panel 20 or other components of the vehicle such as a gearshift lever. The down-stops 150 preferably orient the interface device 10 in the folded position to mitigate any interference with the accessibility and visibility of the control panel 20. The interface device 10 can be mounted in front of a car radio or heating and ventilation control cluster while still permitting user access when the interface device 10 is in the folded position. When in the folded position (FIG. 3), the backside to the interface device 10 can serve as a work surface (e.g. as a notepad holder) and can provide theft security by obscuring the nature of the interface device 10. Each of the pair of down-stops 150 can optionally further comprise an adjustment mechanism 190 for varying the limit to the pivotal rotation of the computer interface device 10 that defines the folded position. The adjustment mechanism 190 can, for example, comprise one or more set screws threaded through a portion of the down-stops 150 or other similar mechanisms.

The resistance elements 130 provide resistance to the pivotal rotation of the device brackets 110 with respect to the mounting brackets 120 and therefore to the rotation of the computer interface device 10. The resistance to rotation provided by the resistance elements 130 is readily overcome by an occupant of the vehicle. The resistance provided by the resistance elements 130 is preferably sufficient to maintain the static orientation of the computer interface device 10 when it is in positions (e.g. see FIG. 5B) between the in-use position and the folded position. Thus it is possible for an occupant to move the computer interface device 10 from the in-use position for access to the control panel 20 without having to move the computer interface device 10 completely to the folded position. This is particularly useful when access to the control panel 20 is intermittent and the computer interface device 10 will be returned to the in-use position shortly after the access.

It will be apparent to one skilled in the art that numerous modifications and departures from the specific embodiments described herein may be made without departing from the spirit and scope of the present invention.

1. A mounting mechanism for mounting a computer interface device to a control panel of a vehicle, comprising:
a pair of device brackets for fixed attachment to the computer interface device;
a pair of mounting brackets adapted to attachment to the control panel;
a pair of resistance elements, each for pivotally connecting one device bracket to one mounting bracket and for providing resistance to the pivotal rotation of each device bracket relative to the connected mounting bracket;
a pair of up-stops adapted to limiting the pivotal rotation, in a first direction, of the device brackets relative to the mounting brackets; and
a pair of down-stops adapted to limiting the pivotal rotation, in a second direction, of the device brackets relative to the mounting brackets;
wherein the computer interface device is operable between an in-use position, defined by the up-stops, providing access to the computer interface device by an occupant of the vehicle and a folded position, defined by the down-stops, providing access to an area of the control panel that is obscured by the computer interface device when in the in-use position.

2. The mounting mechanism of claim 1, further wherein each of the pair of resistance elements provide for maintaining the static orientation of one of the pair of device brackets relative to the connected mounting bracket when the computer interface device is in positions between the in-use positions and the folded position

3. The mounting mechanism of claim 1, wherein the up-stops are further adapted to limiting the pivotal rotation of the computer interface device in the in-use position such that the center-of-gravity of the computer interface device is above an axis of rotation around which the pair of device brackets rotate relative to the mounting brackets and such that the center-of-gravity is intermediate the control panel and the axis of rotation; wherein the force of gravity biases the computer interface device to remain in the in-use position and mitigates the effect of vertical movement of the vehicle disturbing the computer interface device from the in-use position.

4. The mounting mechanism of claim 3, each of the pair of up-stops further comprising an adjustment mechanism for varying the limit to the pivotal rotation of the computer interface device that defines the in-use position.

5. The mounting mechanism of claim 1, wherein the down-stops are further adapted to limiting the pivotal rotation of the computer interface device in the folded position, such that the center-of-gravity of the computer interface device is below an axis of rotation around which the pair of device brackets rotate relative to the mounting brackets and such that the center-of-gravity is distal from the control panel relative to the axis of rotation; wherein the force of gravity biases the computer interface device to remain in the folded position and mitigates the effect of vertical movement of the vehicle disturbing the computer interface device from the folded position.

6. The mounting mechanism of claim 5, each of the pair of down-stops further comprising an adjustment mechanism for varying the limit to the pivotal rotation of the computer interface device that defines the folded position.

7. The mounting mechanism of claim 1, further comprising a pair of mounting blocks adapted to attachment to the control panel and wherein each of the pair of mounting brackets attaches to the control panel via attachment to one of the pair mounting blocks.

8. The mounting mechanism of claim 1, wherein the pair of mounting brackets is adapted to attachment to the control panel through one or more apertures in the control panel.

9. The mounting mechanism of claim 1, wherein the pair of mounting brackets is adapted to attachment to the control panel by attachment to a substructure of the control panel.

10. The mounting mechanism of claim 1, wherein the pair of mounting brackets is adapted to removable attachment to the control panel.
